(19) United States
(12) Patent Application Publication
(10) Pub. No.: US 2010/0156998 A1
(43) Pub. Date: Jun. 24, 2010

(54) METHOD AND APPARATUS FOR PRINTING

(76) Inventors: Nobuo Matsumoto, Cupertino, CA (US); Deane A. Gardner, Cupertino, CA (US)

Correspondence Address: FISH & RICHARDSON P.C., PO BOX 1022, MINNEAPOLIS, MN, 55440-1022, US

(21) Appl. No.: 12/340,389

(22) Filed: Dec. 19, 2008

(51) Int. Cl. B41J 2/045

(52) U.S. Cl. 347/68

(57) ABSTRACT

Methods and apparatus for printing are described. A first mode of printing includes actuating a set of two or more actuators configured to drive printing fluid ejection from a corresponding set of two or more nozzles. In response to a drive signal, each actuator pressurizes a corresponding pumping chamber and ejects a printing fluid from a nozzle in fluid communication with the pumping chamber. The printing fluid ejected from the set of two or more nozzles represents a single pixel of an image being printed. A second mode of printing is in response to determining that a nozzle in the set of nozzles is operating defectively, and includes adjusting the one or more drive signals to the one or more remaining nozzles in the set such that the volume of printing fluid ejected from the remaining nozzles compensates for a lack of printing fluid ejected from the defective nozzle.

### TECHNICAL FIELD

The following description relates to printing from a fluid ejection system.

### BACKGROUND

A fluid ejection system, for example, an ink jet printer, typically includes an ink path from an ink supply to an ink nozzle assembly that includes nozzles from which ink drops are ejected. Ink is just one example of a fluid that can be ejected from a jet printer. Ink drop ejection can be controlled by pressurizing ink in the ink path with an actuator, for example, a piezoelectric deflector, a thermal bubble jet generator, or an electrostatically deflected element. A typical printhead module has a line or an array of nozzles with a corresponding array of ink paths and associated actuators, and drop ejection from each nozzle can be independently controlled. In a so-called “drop-on-demand” printhead module, each actuator is fired to selectively eject a drop at a specific location on a medium. The printhead module and the medium can be moving relative one another during a printing operation.

In one example, a printhead module can include a silicon printhead body and a piezoelectric actuator. The printhead body can be made of silicon etched to define pumping chambers. Nozzles can be defined by a separate substrate (i.e., a nozzle layer) that is attached to the printhead body. The piezoelectric actuator can have a layer of piezoelectric material that changes geometry, or flexes, in response to an applied voltage. Flexing of the piezoelectric layer causes a membrane to flex, where the membrane forms a wall of the pumping chamber. Flexing the membrane thereby pressurizes ink in a pumping chamber located along the ink path and ejects an ink drop from a nozzle at a nozzle velocity. The piezoelectric actuator is bonded to the membrane.

### SUMMARY

This invention relates to printing from a fluid ejection system. In general, in one aspect, the invention features a printhead module that includes a printhead body, a nozzle plate, multiple actuators and a circuit. The printhead body includes multiple pumping chambers. Each pumping chamber includes a receiving end configured to receive a printing fluid from a printing fluid supply and an ejecting end for ejecting the printing fluid from the pumping chamber. The nozzle plate includes multiple nozzles formed through the nozzle plate. Each nozzle is in fluid communication with a pumping chamber and receives printing fluid from the ejecting end of the pumping chamber for ejection from the nozzle. Each of the multiple actuators is configured to pressurize a pumping chamber, so as to eject printing fluid from a nozzle that is in fluid communication with the ejecting end of the pumping chamber. The circuit is electrically connected to each actuator. The actuators are electrically connected such that a set of two or more actuators is actuated by a single drive signal transmitted by the circuit and printing fluid ejected from a set of two or more nozzles corresponding to the set of actuators represents a single pixel of an image being printed.

Implementations of the invention can include one or more of the following features. The actuators can be piezoelectric actuators. Each piezoelectric actuator can be positioned over a pumping chamber and can include a piezoelectric material configured to deflect and pressurize the pumping chamber in response to the drive signal. In other implementations, the actuators are thermal actuators. The set of two or more nozzles can include two or more nozzles adjacent each other in an array of nozzles.

In general, in another aspect, the invention features a method of printing that includes a first mode of printing and a second mode of printing. The first mode of printing includes actuating a set of two or more actuators configured to drive printing fluid ejection from a corresponding set of two or more nozzles. In response to a drive signal, each actuator pressurizes a corresponding pumping chamber and ejects a printing fluid from a nozzle in fluid communication with the pumping chamber. The printing fluid ejected from the set of two or more nozzles represents a single pixel of an image being printed. The second mode of printing is in response to determining that a nozzle in the set of nozzles is defective, and includes adjusting the one or more drive signals to the one or more remaining nozzles in the set such that the total volume of printing fluid ejected from the remaining nozzles compensates for a lack of printing fluid ejected from the defective nozzle.

Implementations of the invention can include one or more of the following features. A single drive signal transmitted by a circuit electrically connected to the set of two or more actuators can simultaneously drive the set of two more nozzles. In other implementations, each nozzle in the set can be driven by a separate drive signal, where the drive signals for the set of the nozzles are offset by a timing delay. The defective nozzle may have a corresponding actuator that is unresponsive to a drive signal (i.e., the nozzle is “stuck off”) and adjusting the one or more drive signals can increase the volume of printing fluid ejected from the remaining nozzles. Alternatively, the defective nozzle may have a corresponding actuator that is continuously or arbitrarily active (i.e., rather than selectively active in response to a drive signal) causing the nozzle to continually or arbitrarily eject printing fluid (i.e., nozzle is “stuck on”). In this instance, the actuator that corresponds to the defective nozzle can be electrically disconnected from a source of drive signals (i.e., switched into a stuck off state). Adjusting the one or more drive signals can also increase the volume of printing fluid ejected from the remaining nozzles.

In general, in another aspect, the invention features a printhead module including a printhead body, a nozzle plate and multiple actuators. The printhead body includes multiple pumping chambers, where each pumping chamber includes a receiving end configured to receive a printing fluid from a printing fluid supply and an ejecting end for ejecting the printing fluid from the pumping chamber. The nozzle plate includes multiple nozzles formed through the nozzle plate. Each nozzle is in fluid communication with a pumping chamber and receives printing fluid from the ejecting end of the pumping chamber for ejection from the nozzle. The multiple nozzles are grouped into sets of two or more nozzles which correspond to sets of two or more actuators. The printing fluid ejected from a set of two or more nozzles represents a single pixel of an image being printed. The multiple actuators are grouped into sets of two more actuators corresponding to sets of two or more nozzles. Each actuator is configured to pressurize a pumping chamber, so as to eject printing fluid from one nozzle that is in fluid communication with the ejecting end of the pumping chamber. A nozzle included in a first set of two or more nozzles is a defective nozzle that was continually or arbitrarily ejecting printing fluid and the actuator corresponding to the defective nozzle was deliberately electrically disconnected from a source of drive signals such that the actuator became inactive and no printing fluid was thereafter ejected from the nozzle. A drive signal to a first set of actuators corresponding to the first set of nozzles was adjusted to increase the volume of printing fluid ejected from the remaining nozzles in the set.

Implementations of the invention can realize one or more of the following advantages. Using a set of drops ejected from a set of independently actuated nozzles to represent a single pixel of an image allows for compensation by one or more other nozzles in a set for a defective nozzle included in the set. For example, if a nozzle is stuck off, meaning it will not eject printing fluid in response to a drive signal, the volume of printing fluid ejected from one or more of the other nozzles in the set can compensate for the lack of printing fluid ejected from the defective nozzle. The combined volume of two more drops of printing fluid required to cover the same surface area representing a single pixel is less than the volume of a single larger drop required to cover the same surface area. Additionally, the two or more drops have a lesser thickness than the single drop. As such, less printing fluid is required, which can reduce the cost of printing. For example, if using an ultraviolet cured printing fluid, less photo initiative is required for the combined two or more smaller drops. Photo initiative can be relatively expensive, and using less therefore reduces printing costs. Using smaller drop sizes can also provide a smoother line edge.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is an exploded cross-sectional side view of a portion of a printhead.

FIG. 1B is a cross-sectional side view of the portion of a printhead shown in FIG 1A.

FIG. 2 is a plan view of a portion of a printhead.

FIG. 3A is a schematic representation of an image printed by a printhead with a defective nozzle.

FIG. 3B is a schematic representation of an image printed by the printhead with compensation for the defective nozzle.

FIG. 4A is a schematic representation of prior art printhead circuitry.

FIG. 4B is a schematic representation of printhead circuitry where a set of nozzles are driven by a single drive signal.

FIG. 5A is a schematic representation of an array of nozzles grouped into sets.

FIG. 5B is a schematic representation of an alternative array of nozzles.

FIG. 6 is a flowchart showing an example process for printing in a first and a second mode.

FIG. 7 is a schematic representation of a side view of printing fluid drops.

Like reference symbols in the various drawings indicate like elements.

### DETAILED DESCRIPTION

Methods are described for printing an image on a substrate. The term “image” or “digital image” is used herein to describe whatever is represented by printing fluid ejected from a printhead onto a substrate, which by illustrative example can include a printed picture and/or text. The printing fluid can be ink but can also be other liquids, for example, electroluminescent material used in the manufacture of liquid crystal displays or liquid metals used in circuit board fabrication, or biological fluid. The smallest piece of information of the digital image is referred to herein as a pixel.

Typically, a printhead module includes multiple nozzles and each nozzle ejects a printing fluid droplet that represents a single pixel. However, in some instances, droplets from more than one nozzle ejecting fluid from a single pumping chamber controlled by a single actuator can be combined to represent a single pixel. A difficulty with printhead modules relying on a single nozzle to eject a droplet representing a pixel, or even multiple nozzles that are controlled by a single actuator, is that a failure of the nozzle or the actuator results in there being no printing fluid ejected to represent the corresponding pixel.

Methods and apparatus are described herein where a set of two or more actuators are configured to drive printing fluid ejection from a corresponding set of two or more nozzles. In response to a drive signal, each actuator pressurizes a corresponding pumping chamber and ejects a printing fluid from a nozzle in fluid communication with the pumping chamber. The printing fluid ejected from the set of two or more nozzles together represents a single pixel of an image being printed. Each nozzle ejects printing fluid from its own corresponding pumping chamber, and each pumping chamber is pressurized by its own corresponding actuator. All of the actuators in the set can be driven by a single drive signal, such that they are actuated simultaneously.

By providing more than one independently actuated nozzle for each pixel of an image being printed, if one nozzle fails, printing integrity can be maintained. For example, the volume of printing fluid ejected from the one or more other nozzles associated with the pixel can be increased to compensate for the failed nozzle, as shall be described further below. For clarity, the term “failed nozzle” or “defective nozzle” as used herein refers to a nozzle that is operating defectively. For example, if the actuator driving the nozzle is defective, then the nozzle operates defectively, although the nozzle itself may not have a defect. In other examples, the nozzle itself can have a defect, e.g., be plugged, cause the nozzle to operate defectively.

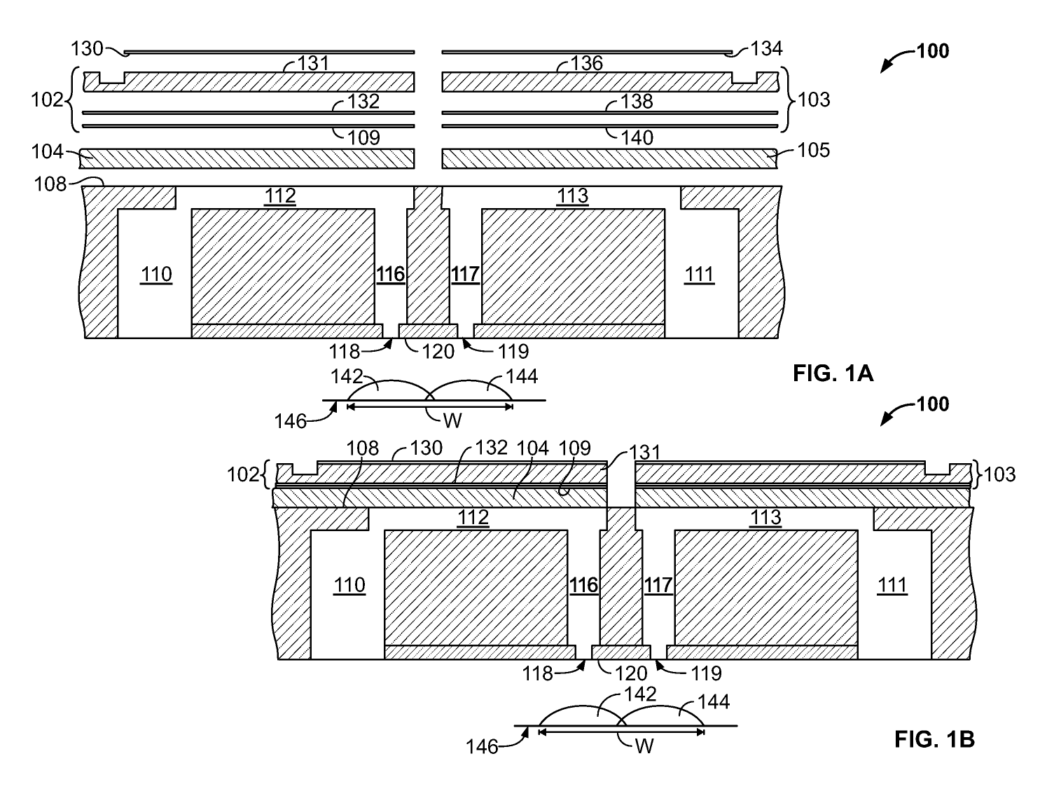

Referring to FIGS. 1A and 1B, for illustrative purposes, an example printhead module 100 is shown. A cross-sectional view of a portion of the printhead module 100 is shown and FIG. 1A shows the upper section in an exploded view. The printhead module 100 includes a substrate 108 in which multiple fluid flow paths are formed (only two flow paths are shown). The printhead module 100 also includes multiple actuators to cause fluid (e.g., ink) to be selectively ejected from the flow paths. Thus, each flow path with its associated actuator provides an individually controllable fluid ejector.

In the example printhead module 100 shown, the actuators 102 and 103 are piezoelectric actuators. However, it should be understood that other configurations of actuators can be used with the techniques described herein, and piezoelectric actuators are but one example for illustrative purposes. As another example, a thermal actuator, e.g., as used in thermal ink jet printheads, can be used.

Referring again to FIGS. 1A and 1B, in this implementation of a printhead module, a first actuator 102 is bonded to a first membrane 104, and a second actuator 103 is bonded to a second membrane 105. An inlet fluidically connects a fluid supply (not shown) to a substrate 108. The inlet is fluidically connected to a first inlet passage 110 through a channel (not shown). The first inlet passage 110 is fluidically connected to a first pumping chamber 112. The first pumping chamber 112 is fluidically connected to a first descender 116 terminating in a first nozzle 118. The first nozzle 118 can be defined by a nozzle layer 120 attached to the substrate 108. The same inlet or a different inlet can be fluidically connected to a second inlet passage 111, which is fluidically connected to a second pumping chamber 113. The second pumping chamber 113 is fluidically connected to a second descender 117 terminating in a second nozzle 119.

Referring to the left side of the drawing, the first membrane 104 is formed on top of the substrate 108 in close proximity to the first pumping chamber 112, e.g., a lower surface of the first membrane 104 can define an upper boundary of the first pumping chamber 112. The first actuator 102 is disposed on top of the first membrane 104, and an adhesive 109 is between the first actuator 102 and the first membrane 104. It should be understood that in other implementations, the membranes 104 and 105 can be excluded, and the piezoelectric layers 130 and 140 themselves can form a boundary of the pumping chambers 112, 113. In implementations where the printing fluid can corrode the piezoelectric material, the surface forming the boundary of the pumping chamber can be protected by a protective layer, for example, a polyimide layer such as Upilex® or Kapton®.

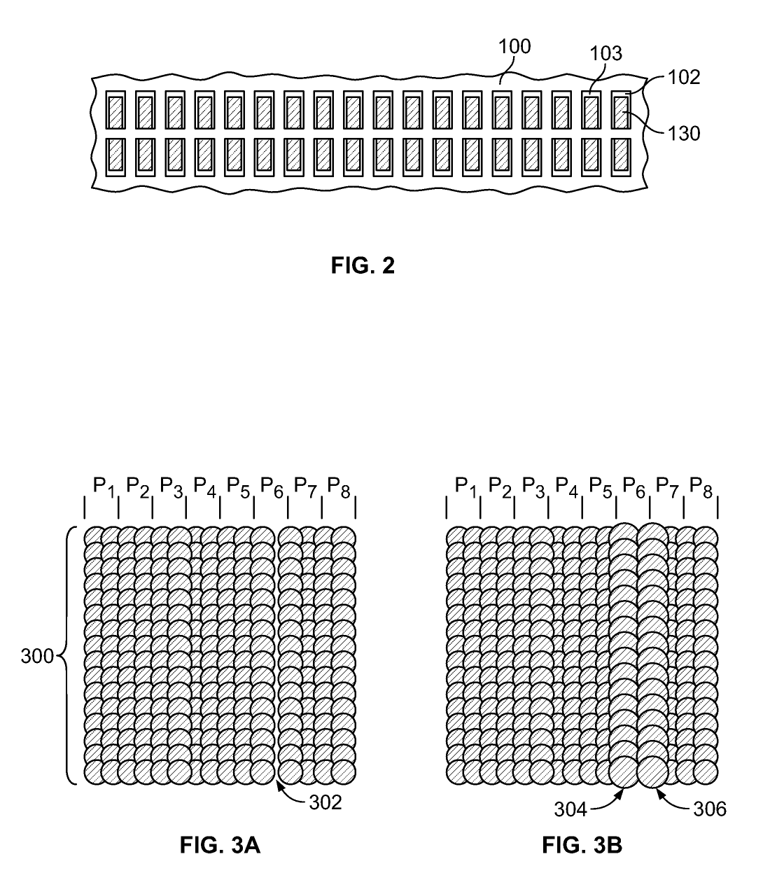

Referring to FIG. 2, a plan view is shown of a portion of the printhead module 100. Each pumping chamber has a corresponding electrically isolated actuator that can be actuated independently. In this implementation, an array of actuators formed from two rows of actuators (e.g., 102 and 103) are shown. The two rows of actuators correspond to an array of two rows of pumping chambers, which can correspond to an array of two rows of nozzles beneath the array of pumping chambers.

Referring again to FIGS. 1A and 1B, in this implementation, the first actuator 102 includes a first piezoelectric layer 131 between electrodes 130 and 132, to allow for actuation of the first actuator 102 by a circuit. For example, the electrode 130 can be a first drive electrode and electrode 132 can be a first ground electrode. A voltage applied to the first drive electrode 130 creates a voltage differential across the first piezoelectric layer 131, causing the piezoelectric material to deform. This deformation can deflect the first membrane 104 into the first pumping chamber 112, thereby changing the volume of fluid in the first pumping chamber 112. In response to the volume change in the first pumping chamber, a first drop 142 of fluid is ejected from the first nozzle 118 of the printhead module. The second actuator 103 is similarly formed and includes a second piezoelectric layer 136 between electrodes 134 and 138. Deformation of the piezoelectric layer causes a second drop 144 of fluid to be ejected from the second nozzle 119.

The first and second drops 142 and 144 are deposited on a substrate 146 and represent a single pixel of width w of the image being printed. The drops are ejected from the nozzles 118 and 119 respectively. Each nozzle 118 and 119 is independently actuated. That is, the printing fluid ejected from each nozzle is supplied by an independent pumping chamber, i.e., pumping chambers 112 and 113. The pumping chambers 112 and 113 are independently pressurized by the first and second actuators 102 and 103 respectively. In some implementations, a single drive signal can apply a voltage to the drive electrodes of both the first and second actuators 102 and 103. In other implementations, separate drive signals can apply the voltages. For example, in some implementations, there may be a slight timing delay desired between ejecting printing fluid from the first and second nozzles. In such an instance, independent drive signals can be used for each actuator. In both implementations, in normal operation (assuming the nozzles corresponding to the pixel and the adjacent pixel are functioning) the two nozzles are driven by the same drive pattern. That is, both nozzles are either on or off at the same time (or substantially the same time if there is a timing delay), whether driven by a single or individual drive signals.

Referring to FIG. 3A, a plan view of a printed image 300 is shown. In this example, each pair of dots represents one pixel of the image 300. The widths of pixels P₁ to P₈ are schematically represented at the top of the drawing, to illustrate that two printing fluid drops represent a single pixel having a width P₁, P₂, etc. The gap 302 between dots is the result of a failed nozzle. FIG. 3B illustrates how increasing the volume of printing fluid ejected from the second nozzle responsible for the same pixel (e.g., P₆) as the failed nozzle can compensate for the lack of printing fluid ejected from the failed nozzle. The left row 304 of larger sized dots is printed by the second nozzle. Optionally, as shown in this example, the volume of printing fluid ejected from a third nozzle responsible for the adjacent pixel (e.g., P₇) has been increased. The right row 306 of larger sized dots is printed by this third nozzle.

In the example shown in FIGS. 3A and 3B, the failed nozzle was “stuck off”, that is, it was failing to eject any printing fluid. For example, if the actuator corresponding to the nozzle is unresponsive to a drive signal, then the nozzle operates defectively in that no printing fluid is ejected in response to the drive signal. When the nozzle failure results in an absence of printing fluid, increasing the volume ejected from the one or more other nozzles in the set of nozzles responsible for the particular corresponding pixel is a technique for overcoming the failure. In other instances, a failed nozzle can be “stuck on”. That is, the nozzle can eject printing fluid even when not receiving a drive signal, which can result in undesired streaking across the printed image.

A nozzle can be “stuck on” because the actuator is continuously or arbitrary active, i.e., not selectively active in response to a drive signal. In such an instance, the drive electrode of the actuator can be disconnected, for example, trimmed or otherwise altered to eliminate an electrical connection between the drive electrode and a source of the drive signals to the drive electrode. That is, the nozzle can be intentionally put into a “stuck off” state by electrically disconnecting the corresponding actuator. The defective nozzle can then be compensated for by increasing the volume of printing fluid ejected from the one or more other nozzles responsible for the same pixel as the defective nozzle, as is described above.

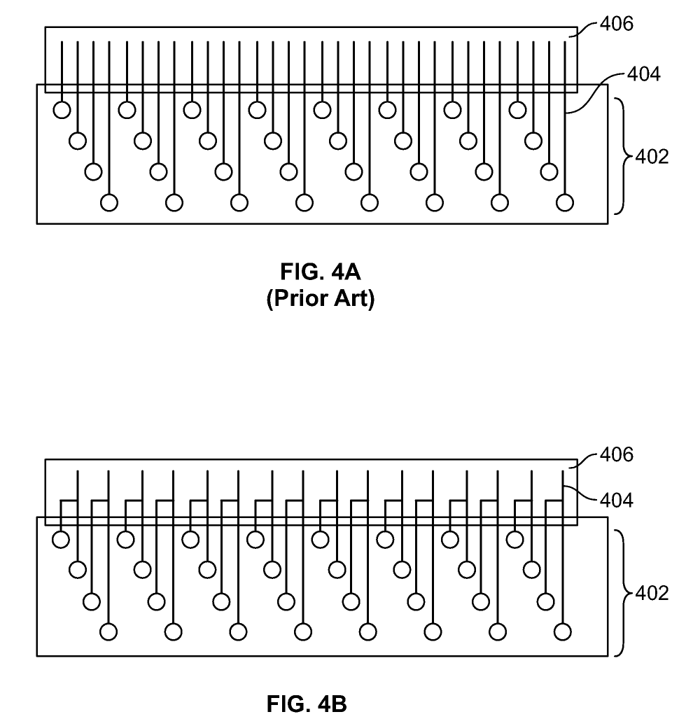

Referring to FIG. 4A, a schematic representation is shown of an array of nozzles 402 connected by traces 404 to a circuit 406. In this example, each nozzle 402 has an independent trace 404 connecting to the circuit 406, and can thereby receive an independent drive signal providing voltage to the corresponding actuator. That is, each nozzle can be selectively and individually actuated. This is a typical configuration when a single nozzle is responsible for a single pixel. However, this configuration can also be used when two or more nozzles are responsible for a single pixel, particularly if it is desired to stagger the timing of driving each nozzle slightly.

Referring to FIG. 4B, a schematic representation is shown of the array of nozzles 402 connected in pairs to traces 404 connecting to the circuit 406. In this example, a pair of nozzles is responsible for a single pixel. The nozzle pair is electrically connected by a trace 404 and thereby is driven by a single drive signal transmitted via the circuit 406. In other implementations, if a set of more than two nozzles are responsible for the same pixel, the entire set can be electrically connected so as to receive the same drive signal.

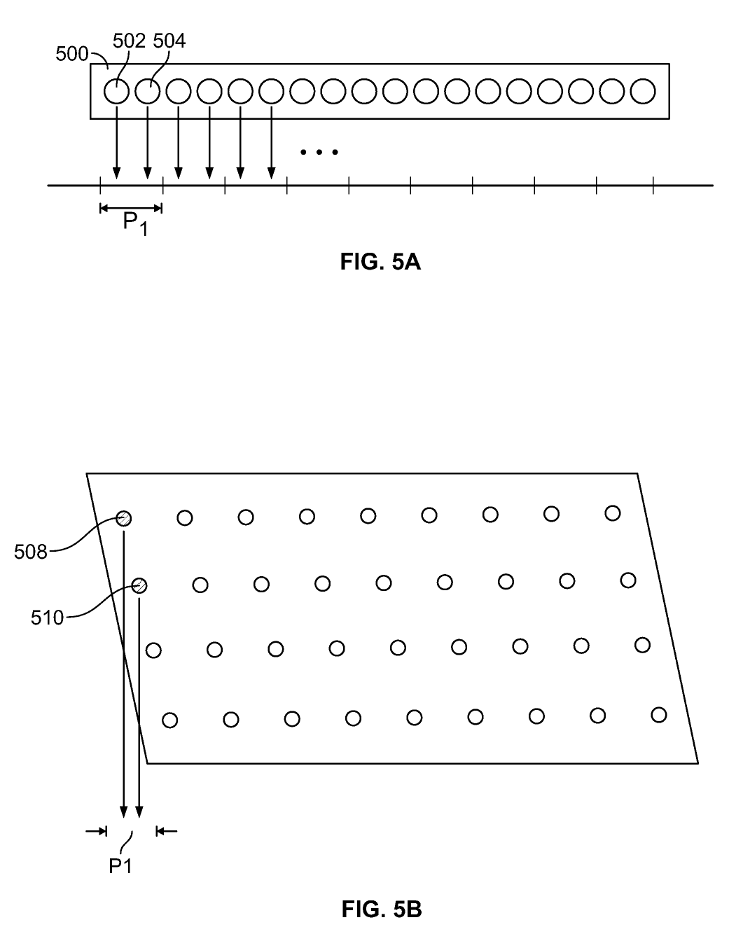

Referring to FIG. 5A, an example plan view of a nozzle face 500 of a printhead module is shown. In this implementation, a pair of adjacent nozzles, for example, nozzles 502 and 504, are responsible for a single pixel. The width P₁ of the pixel is schematically represented beneath the nozzle face 500 for illustrative purposes. In other implementations, two nozzles responsible for the same pixel are not adjacent to one another. An example is shown in FIG. 5B. In this example, the nozzles are included in a 4-row array of nozzles formed in a nozzle face 514. Nozzles 508 and 510 are responsible for the same pixel. The width of the pixel P₁ is schematically represented beneath the nozzle face 514. The two nozzles 508 and 510 are not in the same row in the array. Timing of selectively firing each of the nozzles 508 and 510 can be used, such that the printing fluid droplets ejected from each nozzle are directed to the same pixel location on the substrate.

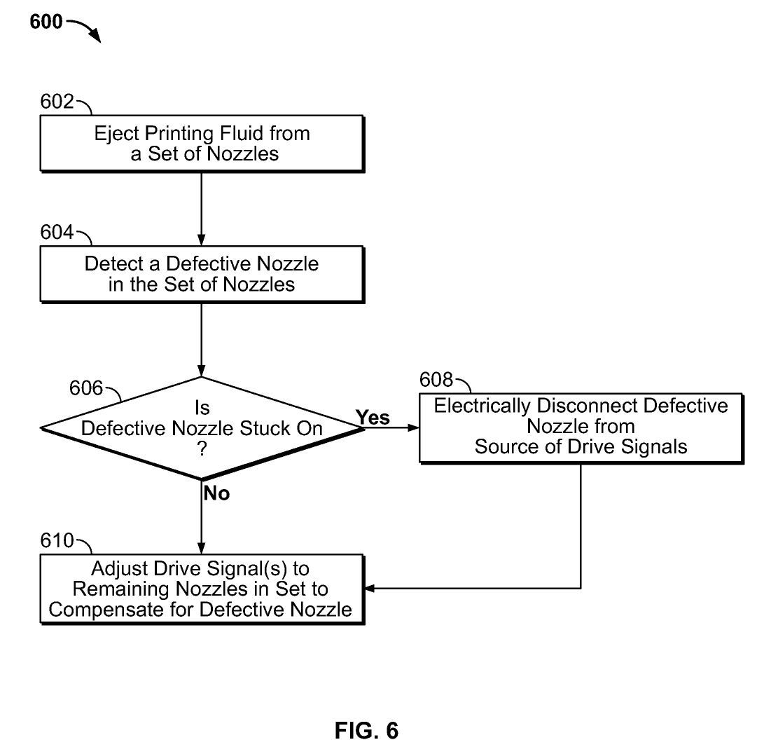

Referring to FIG. 6, a flowchart illustrates an example process 600 for printing in a first mode and a second mode from a printhead module. In a first mode, a printing fluid is ejected from a set of two or more nozzles, where the printing fluid ejected from the set of nozzles represents a single pixel of an image being printed (Step 602). In a second mode, a defective nozzle (i.e., a nozzle operating defectively) in the set of nozzles is detected (Step 604). If the defective nozzle is stuck on (“Yes” branch of Step 606), then the defective nozzle is electrically disconnected from a source of drive signals to the nozzle (Step 608). If the defective nozzle is stuck off, or after having disconnected the defective stuck on nozzle in Step 608, the drive signal (or signals) to other nozzles in the set of nozzles (e.g., the immediately adjacent nozzle or nozzles) is modified to compensate for the defective nozzle (Step 610). That is, the drive signal(s) is adjusted to increase the volume of printing fluid ejected from the remaining nozzles, such that approximately the same volume of fluid is ejected from the remaining nozzles as would be ejected from the entire set of nozzles.

Adjusting the drive signal or signals to the remaining nozzles in a set of nozzles to increase the volume of printing fluid ejected can be accomplished a number of ways. In some implementations, the voltage applied to the actuator is increased to cause a larger volume drop to be ejected. In other implementations, the size of drop ejected can be controlled by adjusting an excitation waveform applied to the actuator. For example, a piezoelectric actuator can be driven by an excitation waveform that includes a selection of one or more ejection pulses from a palette pre-defined ejection pulses. Each ejection pulse applied to the piezoelectric actuator can extrude a bolus of ink through the nozzle corresponding to the actuator. The number of ejection pulses selected from the palette and assembled into a particular excitation waveform can depend on the desired drop size. In general, the larger the drop sought, the greater the number of boluses needed to form it, and hence, the more ejection pulses the excitation waveform will contain. An excitation waveform applied to an actuator is described in further detail in U.S. patent application Ser. No. 11/652,325, entitled “Ejection of Drops Having Variable Drop Size From an Ink Jet Printer”, filed by Letendre et al on Jan. 11, 2007 and published as U.S. Publication No. 2008-0170088, the entire contents of which are hereby incorporated herein by reference.

For illustrative purposes, adjusting an excitation waveform shall be described in reference to the printhead module 100 shown in FIGS. 1A and 1B, although the same techniques can be applied to printhead modules of other configurations. An ejection pulse can begin with a draw phase, in which the piezoelectric material 132 is deformed so as to cause the pumping chamber 112 to enlarge in volume. This causes printing fluid to be drawn from the fluid supply and into the pumping chamber 112.

The deformation that occurs during the draw phase results in a first pressure wave that originates at the source of the disturbance, namely the membrane 104. This first pressure wave travels away from its source in both directions until it reaches a point at which it experiences a change in acoustic impedance. At that point, at least a portion of the energy in the first pressure wave is reflected back toward the source.

Following the lapse of a draw time t_{d}, a waiting phase begins. The duration of the waiting phase, referred to as the “wait time t_{w}”, is selected to allow the above-mentioned pressure wave to propagate outward from the source, to be reflected at the point of impedance discontinuity, and to return to its starting point. This duration thus depends on velocity of wave propagation within the pumping chamber 112 and on the distance between the source of the wave and the point of impedance discontinuity.

Following the waiting phase, the controller begins an ejection phase having a duration defined by an ejection time tₑ. In the ejection phase, the piezoelectric material 132 deforms so as to restore the pumping chamber 112 to its original volume. This initiates a second pressure wave. By correctly setting the duration of the waiting phase, the first and second pressure waves can be placed in phase and therefore be made to add constructively. The combined first and second pressure waves thus synergistically extrude a bolus of ink through the nozzle 118. The extent to which the piezoelectric material is deformed during the draw phase governs the momentum associated with the bolus formed as a result of the ejection pulse.

In an example implementation, the ejection pulse palette has three ejection pulses. Each ejection pulse is characterized by, among other attributes, a pulse amplitude and a pulse delay. The pulse amplitude controls the momentum of a bolus formed by the ejection pulse. The pulse delay of an ejection pulse is the time interval between a reference time and a particular event associated with the ejection pulse. A useful choice for a reference time is the time at which the printer control circuitry sends a trigger pulse. This time can be viewed as the start of an excitation waveform. A useful choice for an event to mark the other end of the pulse delay is the start of the ejection pulse.

The excitation waveform can use all three ejection pulses available in an excitation palette. Other excitation waveforms include subsets of the three available ejection pulses. For example, a two-bolus ink drop can be formed by an excitation waveform having only the first and third ejection pulses, only the first and second ejection pulses, or only the second and third ejection pulses. A one-bolus ink drop can be formed by an excitation waveform having only one of the three available ejection pulses.

In some implementations, the controller is operated such that the intervals between the consecutive pulses are relatively long. When operated in this manner, the bolus extruded by the first pulse begins its flight from the nozzle layer 120 to the substrate before extrusion of the second bolus. This first mode of operation thus leads to a series of independent droplets flying toward the substrate. These droplets combine with each other, either in flight or at the substrate, to form a larger drop.

In other implementations, the intervals between ejection pulses are very short. When operated in this rapid-fire manner, the boluses are extruded so rapidly that they combine with each other while still attached to printing fluid on the nozzle layer 120. This results in the formation of a single large drop, which then leaves the nozzle layer 120 fully formed.

In yet other implementations, the intervals between the ejection pulses are chosen to be long enough to avoid rectified diffusion, but short enough so that the boluses extruded by the sequence of pulses remain connected to each other by ligaments as they leave the nozzle layer 120 on their way to the substrate. In this implementation, the surface tension associated with the inter-bolus ligaments tends to draw the boluses together into a single drop.

To compensate for a defective nozzle, the excitation waveforms applied to the actuators corresponding to the remaining nozzles can be adjusted, as described above, to thereby adjust the size of the drops ejected from remaining nozzles. Accordingly, the print quality can be maintained even with the defective nozzle.

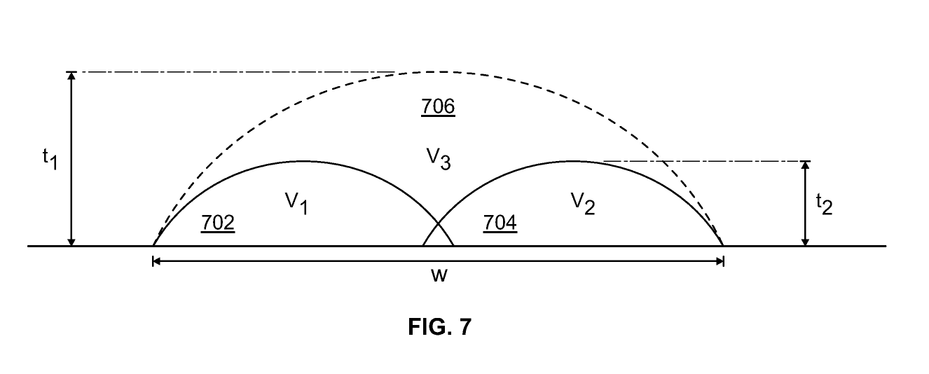

In addition to the advantage of being able to compensate for defective nozzles in an array of nozzles, as described above, using more than one nozzle to represent a single pixel has other advantages. Referring to FIG. 7, a cross-sectional view of a first printing fluid drop 702 and a second printing fluid drop 704 is shown ejected from a first and a second nozzle respectively. The two drops together represent a pixel of an image being printed. The width w of the pixel is shown. Shown in a dotted line is a cross-sectional view of a single, larger drop 706 of printing fluid that would be required to cover the width w of the pixel if a single nozzle was responsible for the pixel. The combined volume of the first and second drops 702, 704, that is V₁+V₂, is less than the volume V₃ of the single, larger drop 706. The thickness t₁ of the single larger drop 706 is also greater than the thickness t₂ of each of the first and second drops.

Due to the reduced volume and thickness of the drops 702, 704, for ultraviolet (UV) cured printing fluids, less photo initiative is required per pixel. Photo initiative is generally expensive and reducing the amount required thereby reduces the printing cost. Additionally, using the same amount of UV light to cure the two drops 702, 704 as to cure the single drop 706 results in a more completely cured printing fluid. Alternatively, to achieve the same level of cure as a single drop 706, less UV light can be used to cure the two drops 702, 704. Either way, an advantage is realized.

Referring again to the printhead module 100 shown in FIGS. 1A and 1B, the first and second membranes 104, 105 can be formed of silicon (e.g., single crystalline silicon), although other examples include a semiconductor material, oxide, glass, aluminum nitride, silicon carbide, other ceramics or metals, silicon-on-insulator, or any depth-profilable substrate. For example, the first and second membranes 104 and 105 can be composed of an inert material and have compliance such that actuation of the first and second actuators 102 and 103 causes flexure of the first and second membranes 104 and 105 sufficient to pressurize fluid in the respective first and second pumping chambers 112 and 113. In some implementations, the first and second membranes 104 and 105 can have a thickness of between about 1 micron and about 150 microns. More particularly, in some implementations the thickness ranges between approximately 8 to 20 microns.

The electrodes 130, 132 can be metal, such as copper, gold, tungsten, nickel-chromium (NiCr), indium-tin-oxide (ITO), titanium or platinum, or a combination of metals. The metals may be vacuum-deposited onto the piezoelectric layer 131. The thickness of the electrode layers may be, for example, about 2 micron or less, e.g. about 0.5 micron.

The membrane 104 is typically an inert material and has compliance so that actuation of the piezoelectric layer causes flexure of the membrane 104 sufficient to pressurize fluid in the pumping chamber. The thickness uniformity of the membrane 104 provides accurate and uniform actuation across the module. The membrane material can be provided in thick plates (e.g. about 1 mm in thickness or more) which are ground to a desired thickness using horizontal grinding. For example, the membrane 104 may be ground to a thickness of about 2 to 50 microns. In some embodiments, the membrane 104 has a modulus of about 60 gigapascal or more. Example materials include glass or silicon.

In the implementations discussed above, the actuator layer includes a piezoelectric layer with an electrode formed thereon, and the electrode facing surface is bonded to the membrane. In other implementations, the electrode can instead be formed on the membrane and the adhesive can be spun-on to the piezoelectric layer to bond the piezoelectric layer to the membrane. In this implementation, the adhesive layer is formed between the lower electrode (e.g., electrode 132) and the piezoelectric layer (e.g., layer 131).

The use of terminology such as “front” and “back” and “top” and “bottom” throughout the specification and claims is for illustrative purposes only, to distinguish between various components of the printhead module and other elements described herein. The use of “front” and “back” and “top” and “bottom” does not imply a particular orientation of the printhead module. Similarly, the use of horizontal and vertical to describe elements throughout the specification is in relation to the implementation described. In other implementations, the same or similar elements can be orientated other than horizontally or vertically as the case may be.

A number of embodiments of the invention have been described. Nevertheless, it will be understood that various modifications may be made without departing from the spirit and scope of the invention. For example, the steps in the process 300 can be performed in a different order than shown and still achieve desired results. Accordingly, other embodiments are within the scope of the following claims.

What is claimed is:

1. A printhead module, comprising:
a printhead body including multiple pumping chambers, where each pumping chamber includes a receiving end configured to receive a printing fluid from a printing fluid supply and an ejecting end for ejecting the printing fluid from the pumping chamber;
a nozzle plate including multiple nozzles formed through the nozzle plate, where each nozzle is in fluid communication with a pumping chamber and receives printing fluid from the ejecting end of the pumping chamber for ejection from the nozzle;
multiple actuators, where each actuator is configured to pressurize a pumping chamber, so as to eject printing fluid from a nozzle that is in fluid communication with the ejecting end of the pumping chamber; and
a circuit electrically connected to each actuator, where the actuators are electrically connected such that a set of two or more actuators is actuated by a single drive signal transmitted by the circuit and printing fluid ejected from a set of two or more nozzles corresponding to the set of actuators represents a single pixel of an image being printed.

2. The printhead module of claim 1, wherein the actuators are piezoelectric actuators and each piezoelectric actuator is positioned over a pumping chamber and includes a piezoelectric material configured to deflect and pressurize the pumping chamber in response to the drive signal.

3. The printhead module of claim 1, wherein the actuators are thermal actuators.

4. The printhead module of claim 1, wherein the set of two or more nozzles includes two or more nozzles adjacent each other in an array of nozzles.

5. The printhead module of claim 1, wherein an actuator included in the set of two or more actuators has been deliberately electrically disconnected from a source of drive signals such that the actuator remains inactive.

6. The printhead module of claim 1, wherein:
a nozzle included in the set of two or more nozzles is a defective nozzle that was continually or arbitrarily ejecting printing fluid and the actuator corresponding to the defective nozzle was deliberately electrically disconnected from a source of drive signals such that the actuator became inactive and no printing fluid was thereafter ejected from the nozzle; and
the drive signal to the set of actuators corresponding to the set of nozzles was adjusted to increase the volume of printing fluid ejected from the remaining nozzles in the set.

7. A method of printing comprising:
a first mode of printing comprising actuating a set of two or more actuators configured to drive printing fluid ejection from a corresponding set of two or more nozzles, where:
in response to a drive signal, each actuator pressurizes a corresponding pumping chamber and ejects a printing fluid from a nozzle in fluid communication with the pumping chamber; and
the printing fluid ejected from the set of two or more nozzles represents a single pixel of an image being printed; and
a second mode of printing in response to determining that a nozzle in the set of nozzles is operating defectively comprising adjusting the one or more drive signals to the one or more remaining nozzles in the set such that the total volume of printing fluid ejected from the remaining nozzles in the set compensates for a lack of printing fluid ejected from the defective nozzle.

8. The method of claim 7, wherein a single drive signal transmitted by a circuit electrically connected to the set of two or more actuators simultaneously drives the set of two more nozzles.

9. The method of claim 7, wherein each actuator in the set of two or more actuators is driven by a separate drive signal, where the drive signals for the set of two or more actuators are offset by a timing delay.

10. The method of claim 7, wherein:
the nozzle operating defectively corresponds to an actuator that is unresponsive to a drive signal; and
adjusting the one or more drive signals increases the volume of printing fluid ejected from the remaining nozzles.

11. The method of claim 7, wherein the nozzle operating defectively is continually ejected printing fluid, the method further comprising:
electrically disconnecting the actuator that corresponds to the nozzle operating defectively from a source of drive signals;
wherein adjusting the one or more drive signals increases the volume of printing fluid ejected from the remaining nozzles.

12. A printhead module, comprising:
a printhead body including multiple pumping chambers, where each pumping chamber includes a receiving end configured to receive a printing fluid from a printing fluid supply and an ejecting end for ejecting the printing fluid from the pumping chamber;
a nozzle plate including multiple nozzles formed through the nozzle plate, where each nozzle is in fluid communication with a pumping chamber and receives printing fluid from the ejecting end of the pumping chamber for ejection from the nozzle and where the multiple nozzles are grouped into sets of two or more nozzles which correspond to sets of two or more actuators and the printing fluid ejected from a set of two or more nozzles represents a single pixel of an image being printed;
multiple actuators grouped into sets of two more actuators corresponding to sets of two or more nozzles, where each actuator is configured to pressurize a pumping chamber, so as to eject printing fluid from one nozzle that is in fluid communication with the ejecting end of the pumping chamber;
wherein a nozzle included in a first set of two or more nozzles is a defective nozzle that was continually or arbitrarily ejecting printing fluid and the actuator corresponding to the defective nozzle was deliberately electrically disconnected from a source of drive signals such that the actuator became inactive and no printing fluid was thereafter ejected from the nozzle, and a drive signal to a first set of actuators corresponding to the first set of nozzles was adjusted to increase the volume of printing fluid ejected from the remaining nozzles in the set.
